(19) United States
(12) Patent Application Publication
(10) Pub. No.: US 2020/0364835 A1
(43) Pub. Date: Nov. 19, 2020

(54) IMAGE PROCESSING DEVICE, IMAGE PROCESSING METHOD AND STORAGE MEDIUM

(71) Applicant: NEC CORPORATION, Tokyo (JP)

(72) Inventors: Madhuri Mahendra NAGARE, Tokyo (JP); Eiji KANEKO, Tokyo (JP); Masato TODA, Tokyo (JP); Masato TSUKADA, Tokyo (JP)

(73) Assignee: NEC CORPORATION, Tokyo (JP)

(21) Appl. No.: 16/966,381

(22) PCT Filed: Jan. 31, 2018
(86) PCT No.: PCT/JP2018/003061

§ 371 Date: Jul. 30, 2020

(51) Int. Cl. G06T 5/00; G06T 7/00

(52) U.S. Cl. CPC G06T 5/005; G06T 7/0002; G06T 2207/30168; G06T 2207/30192; G06T 2207/10036

(57) ABSTRACT

An image processing device 500 for detecting and correcting areas affected by a cloud in an input image is provided. The image processing device 500 includes: endmember extraction unit 501 that extracts a set of spectra of one or more endmembers from the input image; cloud spectrum acquisition unit 502 that acquires one cloud spectrum in the input image; endmember selection unit 503 that compares the endmember spectra with the cloud spectrum, removes one or more spectra from the set of spectra of the endmember spectra, the one or more spectra being same as or similar to the one cloud spectrum, and outputs a resultant set of spectra as an authentic set of spectra; and an unmixing unit 504 that derives, for each pixel in the input image, one or more fractional abundances of the one or more endmembers and a fractional abundance of cloud in the authentic set of spectra, and detects one or more cloud pixels in the input image.

### TECHNICAL FIELD

The present invention relates to an image processing device, image processing method and storage medium storing an image processing program which are capable of accurately determining areas affected by clouds and the amount of contamination in images captured by sensors on space-borne platforms.

### BACKGROUND ART

Satellite images are important information source for monitoring earth surface observation. However, if there is a cloud cover while capturing an image, it poses a serious limitation on the image's reliability for any application to be applied thereafter. In this case, to enhance reliability of the captured image, calculation of abundance of a cloud for each pixel in the image is required.

The NPL 1 discloses a Signal Transmission-Spectral Mixture Analysis (ST-SMA) method for removing a thin cloud cover in satellite images. For the removal, the method employs cloud transmittance values of a cloud cover, which are estimated from cloud abundance values derived by a spectral unmixing technique, to correct thin-cloud-affected pixels by adapting the radiative transfer model. In the spectral unmixing technique, a pixel is assumed to be a mixture of endmembers, and a fractional abundance of each endmember in the pixel is estimated. An endmember is a pure class on the ground observed from satellite side. For each pixel in the input image, the ST-SMA assumes a cloud as an endmember to estimate a fractional abundance of the cloud.

The method derives cloud transmittance values from the estimated cloud abundance values to correct an effect of the cloud. The method in NPL 1 can be divided in two parts: first part is estimation of cloud abundance for each pixel in an image. This cloud abundance can be used by a user in various ways. The second part is application of the obtained cloud abundance to calculate cloud transmittance to remove clouds in an image. The detailed description of two parts of the ST-SMA method is provided below.

FIG. 17 depicts a physical model of capturing a ground reflectance by a satellite with a cloud in the sky. Referring to FIG. 17, the physical model of radiative transfer in the presence of clouds using radiance values is given by equation (1)

s(i,j)=aIr(i,j)Cₜ(i,j)+I[1−Cₜ(i,j)], (1)

where “s(i,j)” is a received radiance at a satellite sensor for a pixel with coordinates “i” and “j”, “a” is an atmospheric transmittance which is generally assumed as 1, “I” is solar irradiance, “r(i,j)” is a reflectance from the ground covered by the pixel (i,j), and “Cₜ(i,j)” is a cloud transmittance observed for the pixel (i,j). This equation assumes cloud absorptance to be 0.

Clouds can reflect, transmit and absorb the incident radiation. Expressing in terms of reflectance “Cᵣ”, absorptance “Cₐ”, transmittance “Cₜ” coefficients, interaction of clouds with incident radiation can be shown below:

Cᵣ+Cₐ+Cₜ=1. (2)

For a plurality of thick cloud (“T”), radiation will be reflected and absorbed completely but not transmitted. When “Tᵣ”, “Tₐ”, “Tₜ” is reflectance, absorptance and transmittance of a thick cloud, respectively, an interaction of incident radiation with a thick cloud can be shown below:

Tₜ=0, ∴Tᵣ+Tₐ=1, (3)

An assumption is made that absorptance and reflectance by a thin cloud are scaled values of absorptance and reflectance of a thick cloud. A further assumption is made; the scaling factor is proportional to the relative thickness of the thin cloud with respect to the thick cloud. Therefore, for a thin cloud, absorptance and reflectance will be the absorptance and reflectance of a thick cloud scaled by a thickness factor (g) of the thin cloud. The g varies from 0 to 1 according to relative thickness of clouds with respect to thick clouds. “g” is 1 for thick clouds. These clouds are opaque clouds for which transmittance is 0.

Substituting absorptance and reflectance values for thin clouds in equation (2) and using equation (3), a cloud transmittance can be estimated as,

Cᵣ=gTᵣ,Cₐ=gTₐ

∴gTᵣ+gTₐ+Cₜ=1

Cₜ=1−g(Tᵣ+Tₐ)

Cₜ=1−g. (4)

Referring to FIG. 17 and equations (1) and (4), the physical model of radiative transfer in the presence of clouds using reflectance values can be expressed in terms of optical properties of clouds as,

x=(1−g)r+gs_{C}+e. (5)

If L is the number of wavelength bands present in the input multispectral image, “x” is a spectral reflectance vector of a pixel of dimension L×1 as observed by the sensor, “s_{c}” is a spectrum (spectral signature) vector of clouds of dimension L×1, and “e” is a noise or model error vector of dimension L×1, “e” can be considered as a part of a pixel which cannot be modelled.

In equation (5), r can be expressed as a mixture of “M” endmembers as shown below:

$$x = ( 1 - g ) {\sum }_{m = 1}^{M} {a}_{m} {s}_{m} + {gs}_{c} + e , \qquad ( 6 )$$

Such that,

$${\sum }_{m = 1}^{M} {a}_{m} = 1 , {a}_{m} \geq 0 , 0 \leq g \leq 1. \qquad ( 7 )$$

“sₘ” is a spectral signature vector of the m^{th} endmember of dimension L×1, “aₘ” is a fractional abundance of the m^{th} endmember. Considering a cloud as an (M+1)^{th} endmember, equation (6) and equation (7) can be modified as,

$$x = {\sum }_{m = 1}^{M + 1} {b}_{m} {s}_{m} + e , \\ where , \\ {a}_{M + 1} = g \text{/} ( 1 - g ) , {s}_{M + 1} = {s}_{c} , \\ {b}_{m} = ( 1 - g ) {a}_{m} , \qquad ( 8 )$$

Such that,

$${\sum }_{m = 1}^{M} {b}_{m} = 1 - g , 0 \leq {b}_{m} \leq g , 0 \leq g \leq 1. \qquad ( 9 )$$

Equation (8) is similar to the linear spectral mixture model (LSMM) with different constraints. The model in equations (8) and (9) can be interpreted as, a cloud is a (M+1)^{th} endmember and g is the fractional abundance of the cloud. Thus “g” which is a relative thickness factor of a cloud can be interpreted as a cloud abundance for a pixel. Consequently, equation (4) indicates a relation between a cloud abundance and a cloud transmittance.

The equation (8) with constraints in equation (9) is solved by the fully constrained linear mixture analysis algorithm to give a fractional abundance of a cloud (and thus g). The equation (8) with constraints in equation (9) can be solved as long as “L>M+1”. Therefore, the technique is most suitable for multispectral or hyperspectral images.

By equation (5), assuming the model error e to be 0 or negligible, the true reflectance of a pixel can be retrieved as shown below:

$$r = \frac{1}{( 1 - g )} ( x - {gs}_{c} ) \qquad ( 10 )$$

A correction in equation (10) cannot be done for a pixel with g=1, it implies that the pixel is covered by thick clouds and should be masked or replaced by another image source.

FIG. 18 is a block diagram showing an exemplary apparatus of the ST-SMA method described by the inventors of the application. It includes: input unit 01, receiving unit 02, cloud spectrum extraction unit 03, endmember extraction unit 04, unmixing unit 05, cloud removal unit 06, and output unit 07. Cloud removal unit 06 corresponds to the second part of the ST-SMA method.

Input unit 01 receives a multispectral or hyperspectral image as an input. Receiving unit 02 receives the number of endmembers other than a cloud in the input image from an operator. Cloud spectrum extraction unit 03 extracts a cloud spectrum from an input image as a spectrum of the brightest pixel in the image. Endmember extraction unit 04 receives the number of endmembers other than a cloud in the input image as an input and extracts equal number of endmember spectra from the input image by employing an unsupervised endmember extraction algorithm, such as Vertex Component Analysis (VCA). Unmixing unit 05 unmixes each pixel in the input image using equation (8) by imposing constraints given by equation (9) to give a fractional abundance of a cloud.

For each pixel, cloud removal unit 06 checks the cloud abundance against a threshold and sorts pixels affected by thick clouds and thin clouds. For pixels affected by thin clouds, cloud removal unit 06 performs correction by using the fractional abundance of a cloud, i.e. retrieves the true reflectance for the pixels using equation (10). Pixels found to be affected by thick clouds are masked. Output unit 07 overlays the thick cloud mask on the corrected thin cloud pixels and sends the image to the display.

In addition, PTL 1 and 2 also describe related techniques.

### CITATION LIST

### Patent Literature

[PTL 1] Japanese Patent Application Laid-open No. 2013-257810
[PTL 2] Japanese Patent Application Laid-open No. 2014-002738

### Non Patent Literature

[NPL 1] Xu, M., Pickering, M., Plaza, A. J. and Jia, X., “Thin Cloud Removal Based on Signal Transmission Principles and Spectral Mixture Analysis,” IEEE Transactions on Geoscience and Remote Sensing (Volume: 54, Issue: 3, March 2016), Page(s): 1659-1669.

### SUMMARY OF INVENTION

### Technical Problem

The method in NPL 1 can identify pixels affected by thin and thick clouds to estimate the true ground reflectance for pixels beneath thin clouds only when a spectrum of a cloud and its abundances are correctly and uniquely determined.

Referring to FIG. 18 which indicates NPL 1, endmember extraction unit 04 extracts a set of endmember spectra [s₁, . . . , sₘ] and provides it to unmixing unit 05. Cloud spectrum extraction unit 03 extracts a cloud spectrum [s_{c}] and provides it to unmixing unit 05. Unmixing unit 05 takes a set of spectra [s₁, . . . , sₘ, Se] as inputs from endmember extraction unit 04 and cloud spectrum extraction unit 03. Unmixing unit 05 determines an abundance corresponding to each spectrum in the set as [d₁, . . . , dₘ, d_{c}]. “d_{c}” is a cloud abundance.

While solving the linear equation (8), it is assumed that there is no cloud spectrum included in the extracted endmember spectra set [s₁, . . . , sₘ]. If the set of endmember spectra contains spectrum which is identical or close to the cloud spectrum, the set inputted to unmixing unit 05 might have multiple cloud spectra which is similar to each other, such as [s₁, s_{c}′, . . . , sₘ, s_{C}]. Then, the cloud abundance value will get distributed for unmixing, however, unmixing unit 05 will take only abundance de corresponding to the cloud spectrum as a cloud abundance. Thus, in such a case, the cloud abundance value d_{c} will be inaccurate. The above unwanted cloud spectrum (s_{c}′) which is contained in a set of endmember spectra is called “a noisy cloud spectrum” hereinafter.

In the algorithm of NPL 1, always there is a possibility that endmember extraction unit 04 extracts a noisy cloud spectrum as a part of a set of endmember spectra, because cloudy images have at least one cloud pixel. Further, there is no process in NPL 1 which can identify and eliminate the noisy cloud spectrum by ensuring only one cloud spectrum (s_{c}), which is extracted by cloud spectrum extraction unit 03, is included in the set used for unmixing a pixel. As a result, the abundances derived by an unmixing algorithm employed by unmixing unit 05 can be ambiguous, which causes deterioration of estimation for the cloud abundance. In addition, in such a case, an algorithm cannot sort whether pixels affected by thin clouds or thick clouds correctly. Furthermore, it cannot ensure accurate retrieval of the true ground reflectance of pixels beneath thin clouds.

In conclusion, the key problem of NPL 1 is that there is no process to ensure absence of the noisy cloud spectrum in a set of spectra [s₁, . . . , sₘ, s_{c}] used for unmixing.

The present invention is made in view of the above mentioned situation. An objective of the present invention is to provide a technique capable of accurately determining areas affected by clouds in images captured by sensors.

### Solution to Problem

In order to solve the above-mentioned problem, a first exemplary aspect of the present invention is an image processing device for detecting and correcting areas affected by a cloud in an input image. The device includes: an endmember extraction unit that extracts a set of spectra of one or more endmembers from the input image; a cloud spectrum acquisition unit that acquires one cloud spectrum in the input image; an endmember selection unit that compares the endmember spectra with the cloud spectrum, removes one or more spectra from the set of spectra of the endmember spectra, the one or more spectra being same as or similar to the one cloud spectrum, and outputs a resultant set of spectra as an authentic set of spectra; and an unmixing unit that derives, for each pixel in the input image, one or more fractional abundances of the one or more endmembers and a fractional abundance of cloud in the authentic set of spectra, and detects one or more cloud pixels in the input image.

A second exemplary aspect of the present invention is an image method for detecting and correcting areas affected by a cloud in an input image. The method includes: extracting a set of spectra of one or more endmembers from the input image; acquiring one cloud spectrum in the input image; comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra; and deriving, for each pixel in the input image, one or more fractional abundances of the one or more endmembers and a fractional abundance of cloud in the authentic set of spectra, and detecting one or more cloud pixels in the input image.

A third exemplary aspect of the present invention is an storage medium storing an image processing program to cause a computer for detecting and correcting areas affected by a cloud in an input image. The program includes: extracting a set of spectra of one or more endmembers from the input image; acquiring one cloud spectrum in the input image; comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra, and outputting a resultant set of spectra as an authentic set of spectra; and deriving, for each pixel in the input image, one or more fractional abundances of the one or more endmembers and a fractional abundance of cloud in the authentic set of spectra, and detecting one or more cloud pixels in the input image.

The program can be stored in a non-transitory computer readable medium.

### Advantageous Effects of Invention

According to the present invention, image processing device, image processing method and storage medium are capable of accurately determining areas affected by clouds in images captured by sensors.

### BRIEF DESCRIPTION OF DRAWINGS

FIG. 1 is a block diagram of the first example embodiment in accordance with the present invention.

FIG. 2 is a graph indicating spectra of endmembers.

FIG. 3 is a flow chart of the procedure of the first example embodiment in accordance with the present invention.

FIG. 4 is a block diagram of the second example embodiment in accordance with the present invention.

FIG. 5 is a flow chart of the procedure of the second example embodiment in accordance with the present invention.

FIG. 6 is a block diagram of the third example embodiment in accordance with the present invention.

FIG. 7 is a table showing cloud spectra.

FIG. 8 is a graph showing pictorial representation of cloud spectra.

FIG. 9 is a flow chart of the procedure of the third example embodiment in accordance with the present invention.

FIG. 10 is a table showing a layout of pixels locations in a subset of an input image.

FIG. 11 is a table showing spectral values of pixels in the subset shown in FIG. 10.

FIG. 12 is a table showing an index number of selected cloud spectrum for pixels in the subset shown in FIG. 10.

FIG. 13 is a block diagram of the fourth example embodiment in accordance with the present invention.

FIG. 14 is a flow chart of the procedure of the fourth example embodiment in accordance with the present invention.

FIG. 15 is a block diagram of the fifth example embodiment in accordance with the present invention.

FIG. 16 is a block diagram showing a configuration of an information processing apparatus.

FIG. 17 is a depiction of the physical model for radiometric transfer in the presence of clouds.

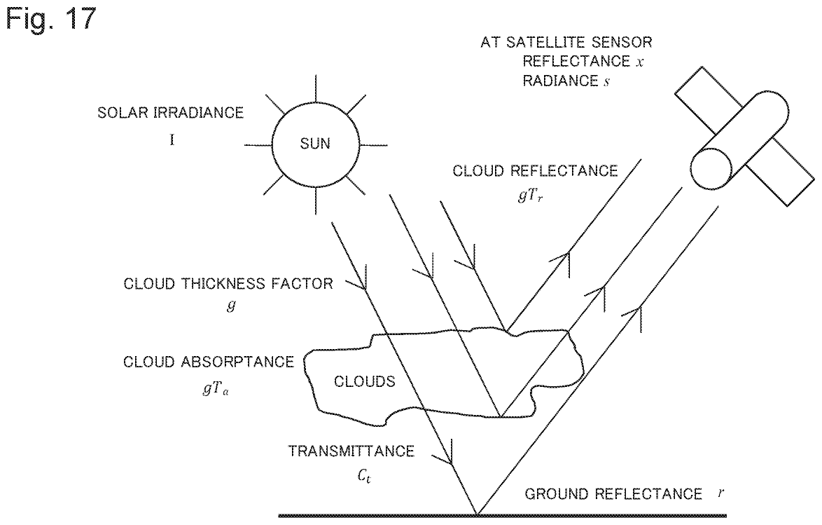

FIG. 18 is a block diagram of the method described in NPL 1 (ST-SMA)

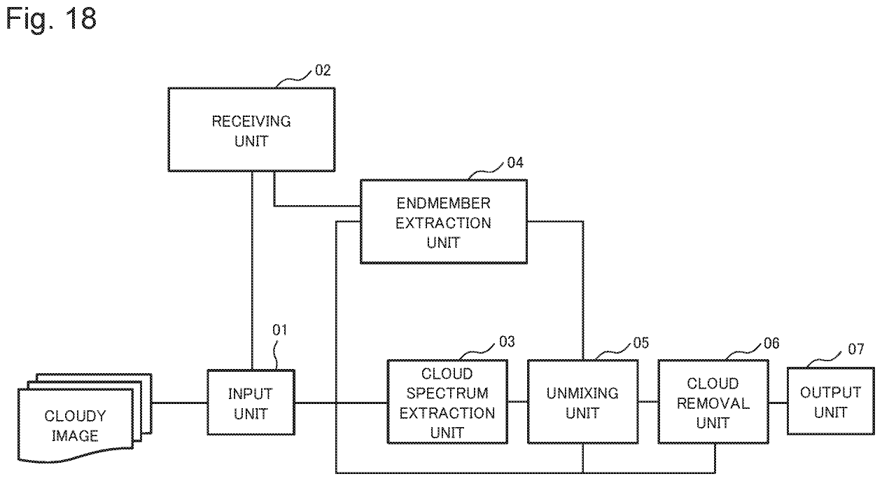

Skilled artisans will appreciate that elements in the figures are illustrated for simplicity and clarity and have not necessarily been drawn to scale. For example, the dimensions of some of the elements in the figures illustrating the physical model for radiometric transfer in the presence of clouds, may be exaggerated relative to other elements to help to improve understanding of the present and alternate example embodiments.

### DESCRIPTION OF EMBODIMENTS

Satellite images which are captured by sensors on space-borne platforms provide huge amount of information about earth surfaces. Many space-borne platforms have sensors capable of capturing multispectral or hyperspectral images from which we can extract much more detailed information about characteristics of objects on the ground than that of RGB images. A multispectral image is an image including response of a scene captured at multiple and specific wavelengths in the electromagnetic spectrum. Generally, images having more than three (RGB) bands are referred to as multispectral images. In the present invention, hyperspectral images are also referred to as the multispectral images, hereinafter.

These images are, however, often affected by the weather conditions while capturing because around two thirds of the earth surface is covered by clouds throughout the year. Consequently, it is difficult to get a cloud free scene for all images. A cloud cover (an area of a cloud which is visible in an image) poses a serious limitation for the use of satellite images in advanced image processing operation, such as Land Use/Land Cover (LU/LC) classification. If images with a cloud cover are used for a high level analysis to acquire land surface information, unreliable results will be obtained.

The detection of an area (pixels in an image) contaminated by clouds and estimation of extent of the contamination are important pre-processing tasks. There could be many types of clouds and different layers of clouds in the image. Here, a thick cloud means an atmospheric cloud which blocks the sensor view completely in a pixel, while a thin cloud blocks the view partially. If a cloud is thin enough, it is possible to retrieve the ground information beneath it to some extent from the given single image. If a cloud is too thick and thereby blocks (occludes) the complete radiation, it is impossible to retrieve the ground information beneath it from the given single image. Therefore, in case of a thick cloud, pixels beneath it should be detected and masked to avoid false analysis. Information beneath a thick cloud can be recovered from information of available other sources.

NPL 1 provides a method to detect pixels affected by thin and thick clouds and to correct pixels affected by a thin cloud based on a spectral unmixing technique and the radiative transfer model. A pixel means a physical point and is a unit element of an image. The ‘spectral unmixing’ means a procedure of deriving constituent endmembers of a pixel and their fractional abundances in the pixel based on a spectrum of each endmember in the pixel. The method employs a cloud spectrum and derives its abundance for the detection and correction. A spectrum (spectral signature) of an object means a reflectance spectrum consisting of a set of reflectance values of the object, one for each wavelength band. An accuracy for the detection and correction depends on the accuracy of the extracted cloud spectrum and its estimated abundance. NPL 1 extracts endmember spectra and a cloud spectrum separately. However, NPL 1 lacks two points to be ensured. That is, first, a cloud spectrum is not extracted by the endmember spectra extraction algorithm, and second, a set of spectra employed by the unmixing algorithm should correspond to only one (single) cloud spectrum extracted by the cloud spectrum extraction algorithm. If the endmember extraction algorithm mistakenly extract a cloud spectrum as one of the endmember spectra, the method in NPL 1 fails to find the un-necessary noisy cloud spectrum, and thus estimates cloud abundance incorrectly, and results in low accuracy for the cloud detection and removal.

Each example embodiment of the present invention addressing the above mentioned issues will be described below, with reference to drawings. The following detailed descriptions are merely exemplary in nature and are not intended to limit the invention or the application and uses of the invention. Furthermore, there is no intention to be bound by any theory presented in the preceding background of the invention or the following detailed description.

### First Example Embodiment

In the first example embodiment, an image processing device 100 which provides a solution to the limitation of NPL 1 will be described. The image processing device 100 eliminates the noisy cloud spectrum which is extracted along with other endmember spectra and included in a set of spectra employed for unmixing so as to accurately calculate and estimate cloud abundance.

### <<Image Processing Device>>

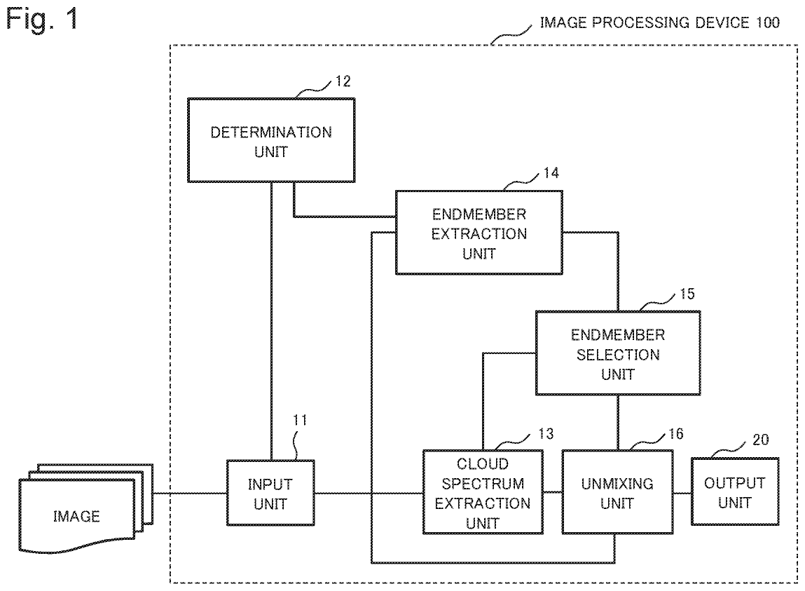

FIG. 1 is a block diagram showing the configuration of image processing device 100 of the first example embodiment in accordance with the present invention. Image processing device 100 includes: input unit 11, determination unit 12, cloud spectrum extraction unit 13, endmember extraction unit 14, endmember selection unit 15, unmixing unit 16, and output unit 20.

Input unit 11 receives an image from sensors on space-borne platforms (Not shown in FIG. 1) via wireless communication, and sends the input image to determination unit 12, cloud spectrum extraction unit 13, endmember extraction unit 14, and unmixing unit 16.

Determination unit 12 determines the number of endmembers other than a cloud in an image. If L is the number of wavelength bands present in the input multispectral image, the number of endmembers is automatically restricted to L minus 2, due to constrains in equation (9). Alternatively, an operator can input the number of endmembers in the image by visual inspection. Determination unit 12 sends the determined number of endmembers to endmember extraction unit 14.

Cloud spectrum extraction unit 13 acquires a multispectral image from input unit 11 and extracts a cloud spectrum from the image. Cloud spectrum extraction unit 13 can extract single cloud spectrum by employing spatial or spectral properties of a cloud in the image. Spatial properties of a cloud can be, such as low standard deviation, homogeneous texture, and/or a less number of edges per unit length. Spectral properties of a cloud can be, such as high reflectance in visible, Near Infra-red bands, and/or low temperatures in thermal bands. For example, cloud spectrum extraction unit 13 can extract a cloud spectrum based on an assumption that pure cloud pixels (each of pixels is completely occupied by a cloud) are much brighter than the land surface in visible and near infrared bands. Accordingly, a cloud spectrum (s_{c}) is extracted as

$${s}_{c} = {x}_{{i}_{m} , {j}_{m}} , \\ ( {i}_{m} , {j}_{m} ) = {argmax}_{( i , j )} {\sum }_{l = 1}^{L} {x}_{i , j} ( l ) , \\ i = 1 , 2 , … , M , j = 1 , 2 , … , N , \qquad ( 11 )$$

where x_{i,j}(l) is the reflectance of the pixel with coordinates (i, j) in the l^{th} spectral band. L, M and N are the number of bands, the number of rows, and the number of columns in an input image, respectively. (iₘ, jₘ) are coordinates of a pixel with maximum sum of reflectance in all wavelength bands. A pixel with maximum sum of reflectance in all wavelength bands is selected as a cloud pixel and a spectrum corresponding to it extracted as a cloud spectrum. Cloud spectrum extraction unit 13 sends the extracted spectrum to endmember selection unit 15 and unmixing unit 16.

Endmember extraction unit 14 acquires a multispectral image from input unit 11 and the number of endmembers from determination unit 12, and extracts the equal number of spectra of the endmembers. An endmember means a pure land cover class in an image. A choice of the land cover class (endmember) depends on an adapted application. For example, in a change detection application, endmembers can be such as vegetation, water. While, in vegetation monitoring, endmembers can be such as cedar, cypress.

If representative pixels for an endmember in an image are identifiable, a mean spectrum of representative pixels can be taken as an endmember spectrum. However, generally, such representative pixels are not easily available. Therefore, endmember extraction unit 14 can perform the extraction by a well-known unsupervised endmember extraction algorithms such as Pixel Purity Index, N-FINDR, and Vertex Component Analysis (VCA). Alternatively, endmember extraction unit 14 can perform the extraction by first using an unsupervised clustering, then selecting endmember spectra as means of respective clusters.

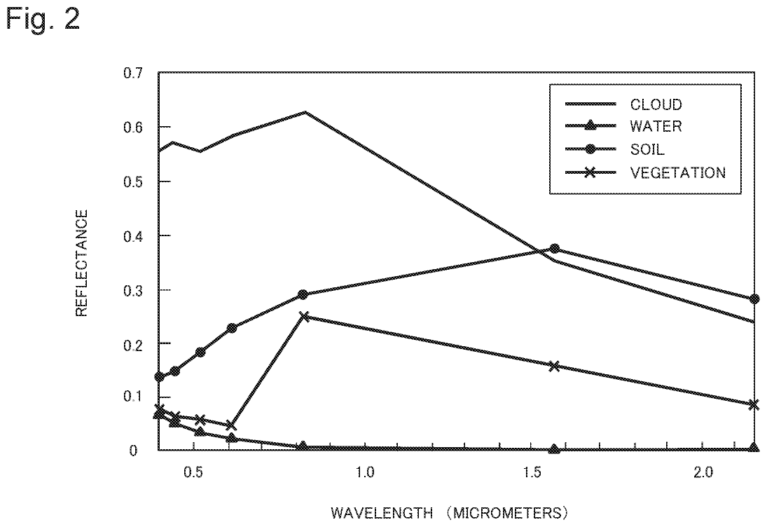

FIG. 2 shows an example of endmembers' (water, soil and vegetation) spectra and a cloud spectrum as a graph with a reflectance as a vertical axis, and wavelength (μm) as a horizontal axis.

Endmember extraction unit 14 sends a set of extracted spectra of endmembers [s₁, . . . , sₘ] to endmember selection unit 15.

Endmember selection unit 15 acquires a cloud spectrum [s_{c}] from cloud spectrum extraction unit 13 and a set of endmember spectra [s₁, . . . , sₘ] from endmember extraction unit 14, and compares the spectra, for example, the cloud spectrum [s_{c}] and each element of the set [s₁, . . . , sₘ] to eliminate the noisy cloud spectrum. When endmember selection unit 15 finds the noisy cloud spectrum in the set of the endmember spectra, such as [s₁, . . . , s_{c}′, . . . , sₘ], endmember selection unit 15 erases the noisy cloud spectrum (s_{c}′). After that, endmember selection unit 15 generates a set of authentic endmember spectra for unmixing. Endmember selection unit 15 can perform the comparison of the input spectra based on a spectral proximity measure. Examples of a spectral proximity measure are: Euclidean distance, spectral angle, and correlation coefficient between two spectra. The spectral angle measure is selected as the most preferred measure for the spectral proximity. A spectral angle measures proximity between two spectra by means of an angle between the spectra in the spectral feature space. A smaller angle indicates that two spectra are more similar. A spectral angle W for two spectra can be determined as

$$W = {cos}^{- 1} ( \frac{x \cdot y}{‖ x ‖ \times ‖ y ‖} ) , \qquad ( 12 )$$

where “·” is a vector dot product, ∥x∥, ∥y∥ are magnitudes of vectors x and y.
The magnitude of the angle (W) is inversely proportional to the degree of similarity between the spectra in the feature spaces.

Endmember selection unit 15 calculates a spectral angle between the cloud spectrum and all spectra in a set of endmember spectra using equation (12). For equation (12), in this case, x is one of the extracted endmember spectra and y is a cloud spectrum. If the angle for a spectrum in the set of endmember spectra is less than a specific threshold, it is assumed to be similar to the cloud spectrum and removed from the set of endmember spectra. The threshold can be determined empirically. After comparing all endmember spectra with the cloud spectrum, endmember selection unit 15 assembles remaining endmember spectra as a set of endmember spectra and sends the set to unmixing unit 16.

Unmixing unit 16 acquires an input multispectral image from input unit 11, a cloud spectrum from cloud spectrum extraction unit 13, and a set of endmember spectra from endmember selection unit 15. For a spectrum of each pixel, unmixing unit 16 determines fractional abundances (a relative proportion of an endmember in a pixel) of all endmembers and a cloud in the pixel, by employing an input cloud spectrum and endmember spectra.

For a spectrum of a pixel, unmixing unit 16 determines coefficients of linear mixture of spectra of endmembers and the cloud, by employing an iterative least square approach, fully constrained linear mixture analysis. The coefficients of the linear mixture model are fractional abundances of the endmembers and the cloud. The unmixing unit 16 performs unmixing such that if spectra of the endmembers and the cloud are scaled by the respective fractional abundance obtained and added linearly, then, the spectrum of the pixel (which has been unmixed) is obtained. The unmixing problem can be defined by equation (8) with constraints given by equation (9). Based on the above description, unmixing unit 16 obtains ‘a fractional abundance of a cloud’ (g) for all pixels in an input images and sends the abundance along with the cloud spectrum employed for unmixing to the output unit 20.

Output unit 20 receives cloud abundance values corresponding to each pixel in an input image and a cloud spectrum employed for unmixing and holds them. Output unit 20 has a memory for storing the obtained cloud abundance values and the cloud spectrum employed for unmixing corresponding to every pixel of the image. Output unit 20 can hold these values as a matrix whose element corresponds to each pixel of the input image. The memory is accessible to a user. The cloud abundance values can be used for various applications. Some applications may be preparing a reliability map for an image indicating purity of pixels, cloud removal, cloud shadow detection or cloud shadow removal. To perform these operations, a cloud spectrum employed for unmixing is also required, which is also stored in the memory. Output unit 20 outputs the stored cloud abundance values and cloud spectra to an external device, via wired or wireless network, at predetermined intervals, triggered by an event or in response to a request from the external device.

### <<Operation of Image Processing Device>>

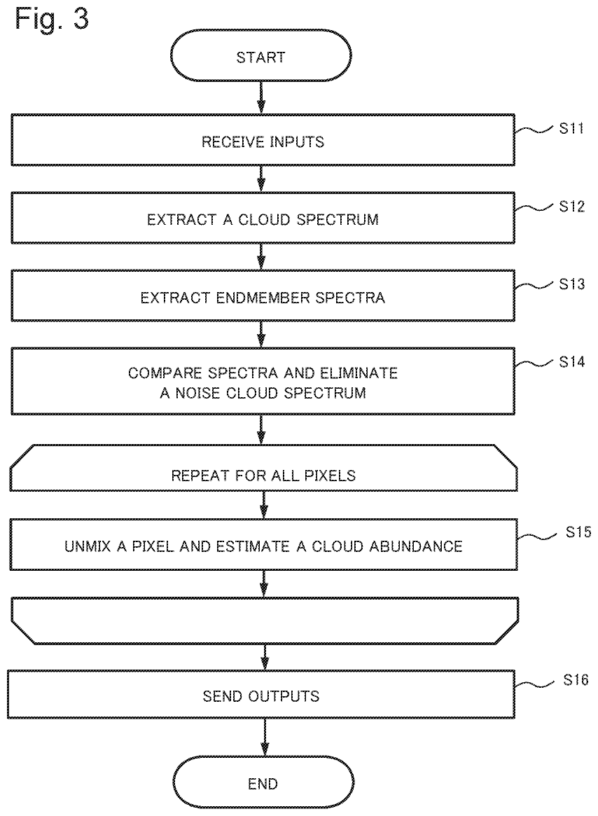

FIG. 3 shows a flowchart which expresses the operation of image processing device 100.

At first, in step S11, input unit 11 receives an input multispectral image and sends it to determination unit 12, cloud spectrum extraction unit 13, endmember extraction unit 14 and unmixing unit 16.

In step S12, cloud spectrum extraction unit 13 extracts a cloud spectrum from the input image. Cloud spectrum extraction unit 13 calculates a sum of reflectance in all wavelength bands for each pixel and extracts a cloud spectrum by employing equation (11). The numbers and kinds of wavelength bands depend on adapted observing sensors. For example, in OLI (Operational Land Imager) on board LANDSTAT 8, the bands are divided into 9 groups, such as Band1 (coastal aerosol) to Band 9 (Cirrus). The extraction of a cloud spectrum is based on a fact that a cloud has high reflectance for a wide range of wavelength from visible to infra-red bands, which are generally present in a multispectral image. Therefore, a pixel with the highest sum of reflectance in all bands is assumed to be a cloud pixel and its spectrum is assumed as a cloud spectrum.

Alternatively, cloud spectrum extraction unit 13 can employ spectral and thermal band tests specific for clouds, if it is available to identify cloud pixels.

In step S13, endmember extraction unit 14 extracts spectra of endmembers other than a cloud from an input image. As the preparations, determination unit 12 determines the number of endmembers other than a cloud in the received image. Alternatively, an operator can input the number of endmembers in the image by visual inspection. Determination unit 12 sends the determined number of endmembers to endmember extraction unit 14. Endmember extraction unit 14 acquires the image from input unit 11 and the number of endmembers from determination unit 12, and extracts the equal number of spectra of the endmembers. Endmember extraction unit 14 can perform extraction by the well-known unsupervised endmember extraction algorithms such as Pixel Purity Index, N-FINDR, and Vertex Component Analysis (VCA). Alternatively, endmember extraction unit 14 can perform the extraction by first using an unsupervised clustering, then selecting endmember spectra as means of respective clusters.

Endmember extraction unit 14 sends a set of extracted spectra of endmembers to endmember selection unit 15.

In step S14, endmember selection unit 15 compares spectra in a set of endmember spectra to the cloud spectrum, and removes the noisy cloud spectrum based on the results of the comparison. Specifically, endmember selection unit 15 receives the cloud spectrum from cloud spectrum extraction unit 13 and the set of endmember spectra from endmember extraction unit 14. Endmember selection unit 15 calculates a spectral angle (W) between the cloud spectrum and each spectrum in the set of endmember spectra by employing equation (12). If the spectral angle for any endmember's spectrum is less than a specific threshold, the endmember is assumed to be similar to a cloud, and the corresponding endmember spectrum is treated as a noisy cloud spectrum and removed from the set of endmember spectra to prevent miscalculation.

The step S15 is performed for all pixels in the input image.

In step S15, unmixing unit 16 unmixes a pixel by using an input set of endmember spectra and a cloud spectrum to give a ‘fractional abundance of a cloud’ (g) in the pixel. Specifically, unmixing unit 16 acquires the input image from input unit 11, the cloud spectrum from cloud spectrum extraction unit 13, and the set of endmember spectra from endmember selection unit 15. For a spectrum of each pixel, unmixing unit 16 determines fractional abundances of all endmembers and a cloud in the pixel, by employing the inputted cloud spectrum and the endmember spectra.

Finally, in step S16, output unit 20 holds the determined cloud abundance values corresponding to each pixel in the input image and the cloud spectrum which has been employed for unmixing. Output unit 20 can have memory to store these values as a matrix style wherein each cell corresponds to a pixel in an image. Furthermore, at predetermined intervals, triggered by an event or in response to a request from the external device which is accessible to a user, output unit 20 outputs the stored cloud abundance values and cloud spectra to the external device, via wired or wireless network.

This is the end of the operation of the image processing device 100.

### Effect of First Example Embodiment

The image processing device 100 of the first example embodiment in accordance with the present invention is capable of accurately determining areas affected by clouds and the amount of contamination in an image by ensuring absence of the noisy cloud spectrum in a set of spectra used for unmixing, and removing effects of thin clouds in images captured by sensors. The reason is that the endmember selection unit 15 compares each spectrum in a set of endmember spectra extracted by endmember extraction unit 13 to a cloud spectrum extracted by cloud spectrum extraction unit 13, and based on the result of the comparison, eliminates a would-be noisy cloud spectrum in the set of endmember spectra. This ensures that there is strictly one cloud spectrum (s_{c}) which is extracted by cloud spectrum extraction unit 13 in a set [s₁, . . . , sₘ, s_{c}] employed to unmix a pixel. As a result, unmixing process can be performed correctly.

Because of this, calculated cloud abundance values become more accurate and reliable than those of NPL 1. This enables accurate detection and correction of areas affected by clouds, by ensuring absence of the noisy cloud spectrum in a set of spectra in a input image.

### Second Example Embodiment

In the second example embodiment, an image processing device, which is capable of performing cloud removal process for a cloud image based on the cloud abundance values explained in the first example embodiment, will be described.

### <<Image Processing Device>>

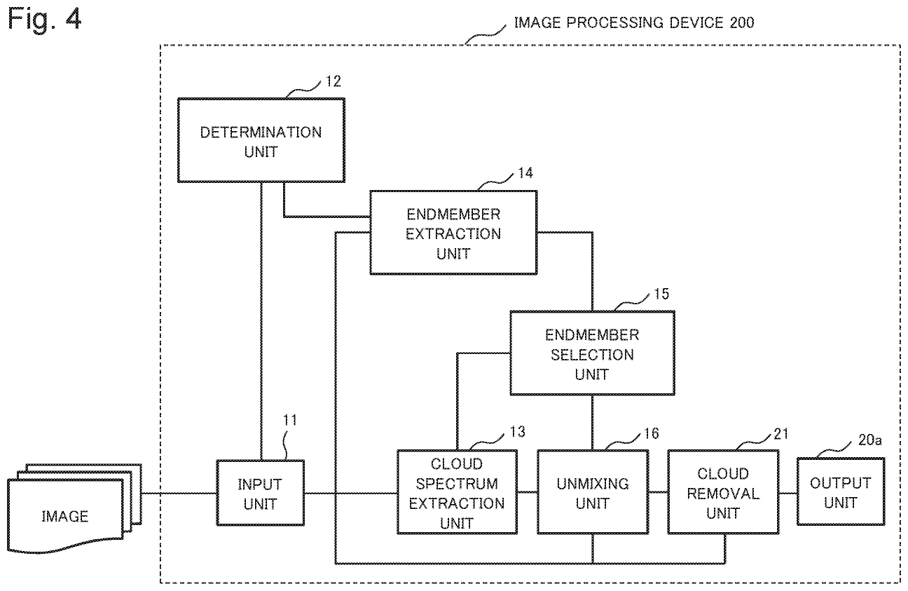

FIG. 4 is a block diagram showing the configuration of the image processing device 200 of the second example embodiment in accordance with the present invention. The image processing device includes: input unit 11, determination unit 12, cloud spectrum extraction unit 13, endmember extraction unit 14, endmember selection unit 15, unmixing unit 16, cloud removal unit 21, and output unit 20a.

Cloud removal unit 21 performs processes to remove clouds from an input image. Specifically, cloud removal unit 21 receives, from unmixing unit 16, a cloud abundance (g) and a cloud spectrum (s_{c}) employed for unmixing for each pixel in an input image. Among cloud pixels, cloud removal unit 21 separates pixels covered by thick clouds from other pixels affected by thin clouds based on a result of comparison of a specific threshold and the obtained fractional abundance of a cloud. An operator can set the threshold in advance. When the abundance of a cloud for a pixel is less than the threshold, the pixel is assumed to be affected by a thin cloud. Then, cloud removal unit 21 retrieves the true ground reflectance (r) by calculation using equation (10) and corrects the input pixel with the calculation result. For clear (no cloud) pixels, g is 0. So, clear pixels will remain unaffected by the equation (10). When the abundance of a cloud for a pixel is greater than or equal to the threshold, the pixel is assumed to be affected by a thick cloud. Then, cloud removal unit 21 masks the pixel. This masked part can be replaced by another image source, such as a captured image on a no-cloud clear day. Cloud removal unit 21 sends the processed image to output unit 20a.

Output unit 20a receives the processed image from cloud removal unit 21 and sends the image as an output to a display (Not shown in FIG. 4). In addition, output unit 20a can store the processed image in a memory. The image data is used for the cloud shadow detection, the cloud shadow removal and other relating processes.

Other units are the same as the first example embodiment.

### <<Operation of Image Processing Device>>

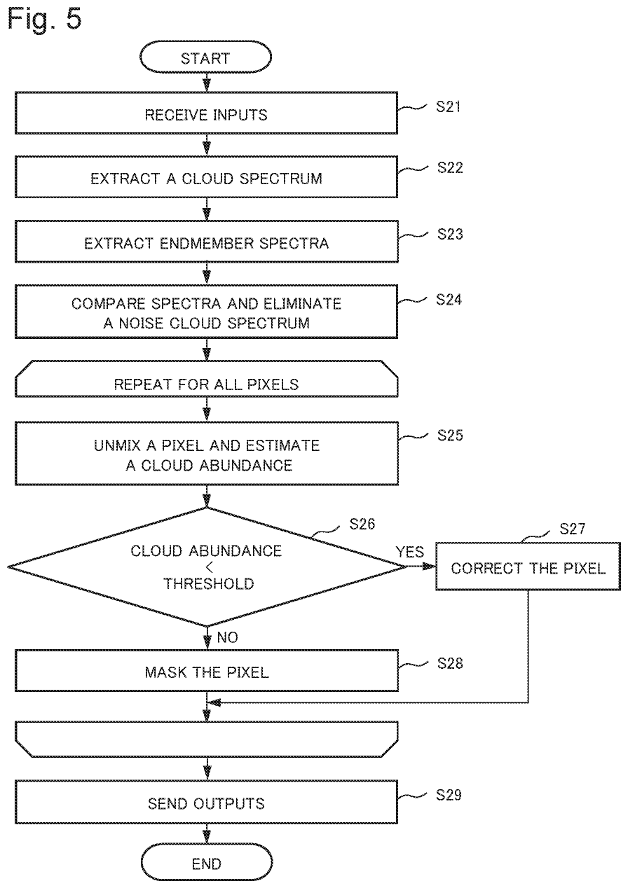

FIG. 5 shows a flowchart which shows the operation of image processing device 200.

The operations of steps S21 to S24 are the same as those of steps S11 to S14 in FIG. 3, respectively.

The operation of steps S25 to S28 are performed for all pixels in an image.

The operation of step S25 is the same as of step S15 in FIG. 3.

In step S26, cloud removal unit 21 receives a cloud abundance (g) and a cloud spectrum (s_{c}) from unmixing unit 16 and checks whether the cloud abundance value for a pixel is less than a threshold or not. For a pixel, if a cloud abundance is less than the threshold, the process moves on to step S27, otherwise the process moves on to step S28.

In step S27, since the input pixel is assumed to be affected by a thin cloud, cloud removal unit 21 retrieves the true ground reflectance (r) by calculation using equation (10) and corrects the input pixel with the calculation result.

In step S28, since the input pixel is assumed to be affected by a thick cloud, cloud removal unit 21 masks out the pixel.

In step S29, output unit 20a stores the above processed image in a memory for cloud detection and removal and sends the processed image to an external device, such as a display.

This is the end of the operation of image processing device 200.

### Effect of Second Example Embodiment

According to the image processing device 200 for the second example embodiment in accordance with the present invention, in addition to the above effects described in the first example embodiment, the image processing device 200 can perform the cloud detection and removal as well, even if a noisy cloud spectrum is extracted by an endmember extraction algorithm. The reason is that based on reliable accuracy of a cloud abundance (g) and a cloud spectrum (s_{c}), cloud removal unit 21 performs more appropriate processing (masking or correcting) for each pixel.

### Third Example Embodiment

In the third example embodiment, an image processing device 300, which can handle a cloud image including more than one cloud type, is described. The image processing device 300 extracts spectra corresponding to all types of clouds present in the image and selects an appropriate spectrum among the extracted cloud spectra for each pixel.

### <<Image Processing Device>>

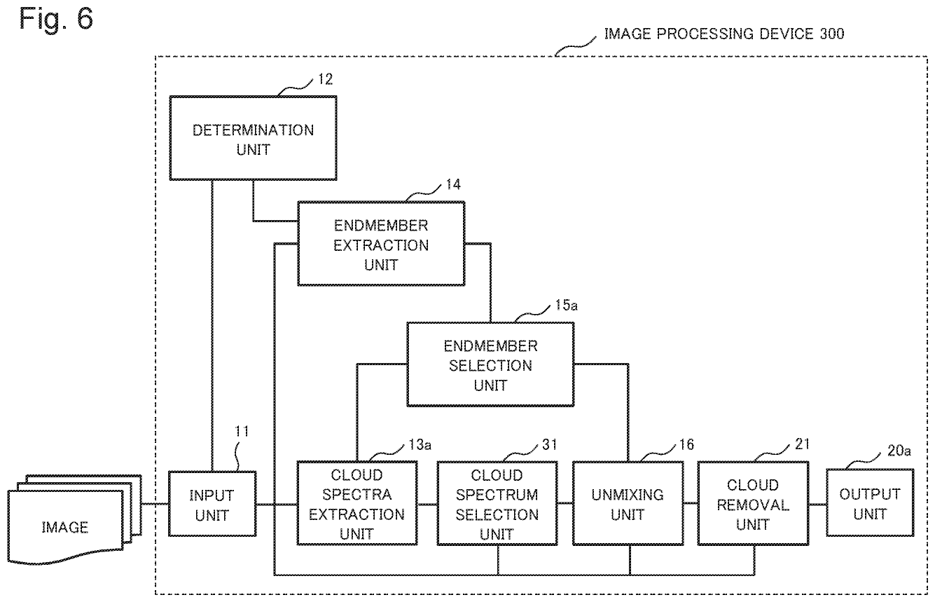

FIG. 6 is a block diagram showing the configuration of the image processing device 300 of the third example embodiment in accordance with the present invention. Image processing device includes: input unit 11, determination unit 12, cloud spectrum extraction unit 13a, cloud spectrum selection unit 31, endmember extraction unit 14, endmember selection unit 15a, unmixing unit 16, cloud removal unit 21 and output unit 20a.

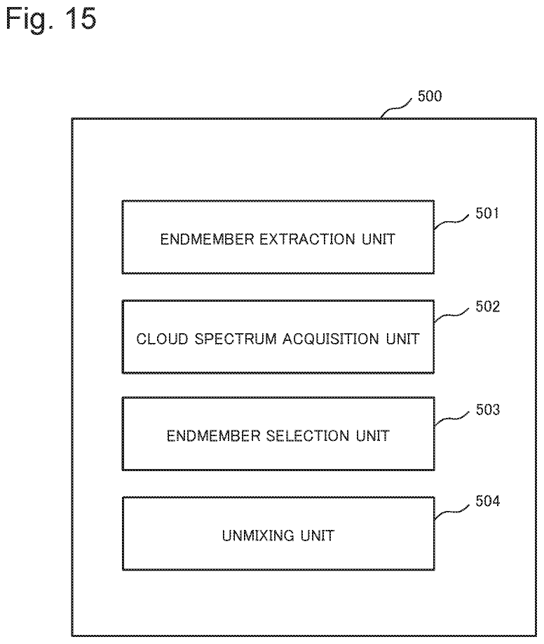

Cloud spectra extraction unit 13a (corresponding to cloud spectrum acquisition unit 502 in FIG. 15 in the fifth example embodiment) obtains the cloud spectra by extracting the cloud spectra from the input image. Specifically, cloud spectra extraction unit 13a receives an inputted image from input unit 11 and extracts spectra corresponding to all types of clouds present in the image. ‘The number of cloud spectra’ (p) extracted from an image depends on the types of clouds present in the image. Cloud spectra extraction unit 13a can detect pixels potentially affected by clouds and perform clustering to find different types of clouds and their representative pixels. A spectrum for each type of a cloud can be calculated as a mean of the spectra for representative pixels. Alternatively, a spectrum for each type of a cloud can be selected as the brightest pixel in respective clusters based on equation (11) as explained in the first embodiment.

Alternatively, a spectrum for each type of a cloud can be calculated as a mean of the spectra for a few top bright representative pixels. Cloud spectra extraction unit 13a sends a set of extracted cloud spectra [s_{c1}, s_{c2}, . . . , s_{cp}] to endmember selection unit 15a and cloud spectrum selection unit 31.

Endmember selection unit 15a receives the set of cloud spectra from cloud spectra extraction unit 13a and the set of endmember spectra [s₁, . . . , sₘ] from endmember extraction unit 14. Endmember selection unit 15a calculates a spectral angle (W) between each of cloud spectrum in the set of cloud spectra and each of endmember spectrum in the set of endmember spectra, such as p×m matrix, by using equation (12) described in the first example embodiment. If the angle for any pair of a cloud spectrum and an endmember spectrum is less than a threshold, the endmember spectrum is assumed to be the same or similar to the cloud spectrum (a noisy cloud spectrum). Next, endmember selection unit 15a removes the noisy cloud spectrum from the set of endmember spectra. After comparing all endmember spectra with all cloud spectra, endmember selection unit 15a assembles the remaining endmember spectra as a set of endmember spectra and sends it to unmixing unit 16.

Cloud spectrum selection unit 31 receives an input image from input unit 11 and a set of extracted cloud spectra from cloud spectra extraction unit 13a. Cloud spectrum selection unit 31 selects a cloud spectrum for a target pixel among the extracted cloud spectra for each pixel. For a pixel, cloud spectrum selection unit 31 selects the spectrally closest cloud spectrum with the pixel's spectrum in a feature space of multiple dimensions, each of which corresponds to a specific wavelength band in the image.

Cloud spectrum selection unit 31 can measure the spectral closeness by means of spectral angle (W) between two spectra by using equation (12). For equation (12), in this case, x is a pixel spectrum and y is one of the extracted cloud spectra. As explained in the first embodiment in accordance with the present invention, the magnitude of the angle (W) is inversely proportional to the degree of similarity between the spectra in the feature spaces. Therefore, among the extracted cloud spectra, a spectrum which gives minimum W with a pixel is selected as a spectrum of a cloud which probably have contaminated the pixel. Alternatively, for a pixel, cloud spectrum selection unit 31 can select a spectrum of a cloud which is spatially closest to the location of the pixel in the input image. Cloud spectrum selection unit 31 sends a matrix containing the selected cloud spectrum for each pixel to unmixing unit 16. The matrix will be explained in detail later.

Unmixing unit 16 employs a cloud spectrum for unmixing pixel-wise as indicated by the matrix of selected cloud spectra obtained from cloud spectrum selection unit 31.

Other units are the same as the first example embodiment.

### <<Operation of Image Processing Device>>

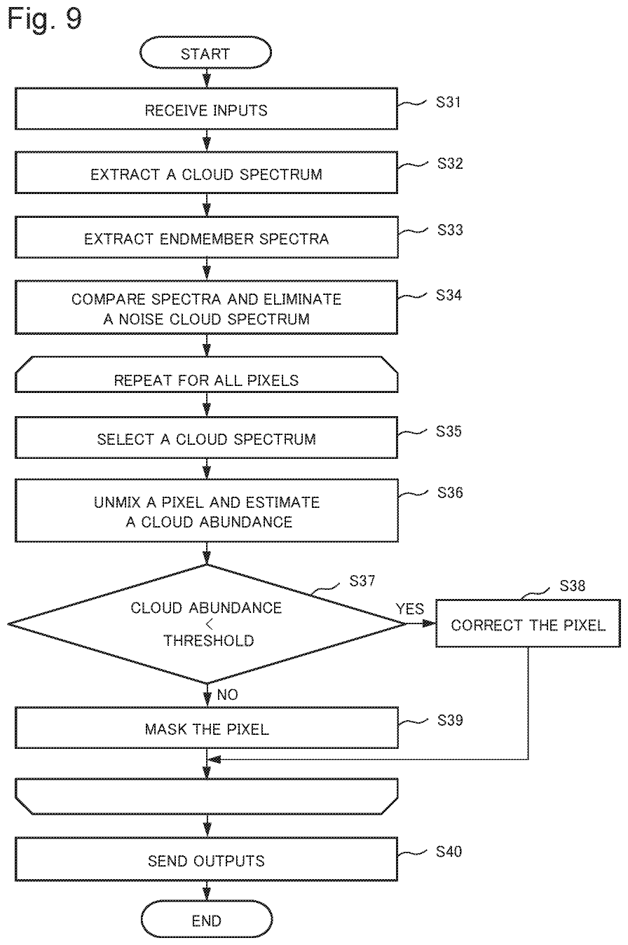

FIG. 9 shows a flowchart which shows the operation of image processing device 300.

The operation of the step S31 is the same as of S21 in FIG. 5.

In step S32, cloud spectra extraction unit 13a extracts spectra corresponding to all types of clouds in an input image. Specifically, cloud spectra extraction unit 13a finds pixels which are potentially affected by clouds by employing spatial and spectral tests. Next, cloud spectra extraction unit 13a applies a clustering algorithm to find clusters of representative pixels for different types of clouds. The clustering algorithm can be an unsupervised clustering algorithm. The unsupervised clustering can be done with well-known algorithms such as k-means clustering, mean shift clustering, ISODATA (Iterative Self-Organizing Data Analysis Technique Algorithm) algorithm and DBSCAN (Density-based spatial clustering of applications with noise). Each cluster represents a type of a cloud. After obtaining clusters, cloud spectra extraction unit 13a extracts a mean spectrum of each cluster and obtains a set of spectra which can be regarded as spectra corresponding to all types of clouds present in the input image.

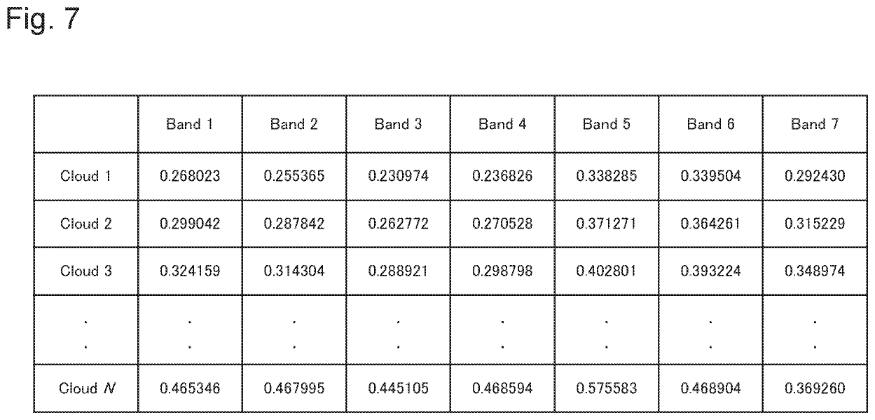

Here, FIG. 7 shows an example of the extracted cloud spectra in a matrix style with cloud No. (number) rows and band No. columns. The cloud No. represents a kind of clouds, and each of the cloud kinds corresponds to the number. Each kind of cloud has a different spectrum. The band No. represents a kind of wavelength bands for example visible, near infrared, short wave infrared bands etc., and each of the bands corresponds to a number.

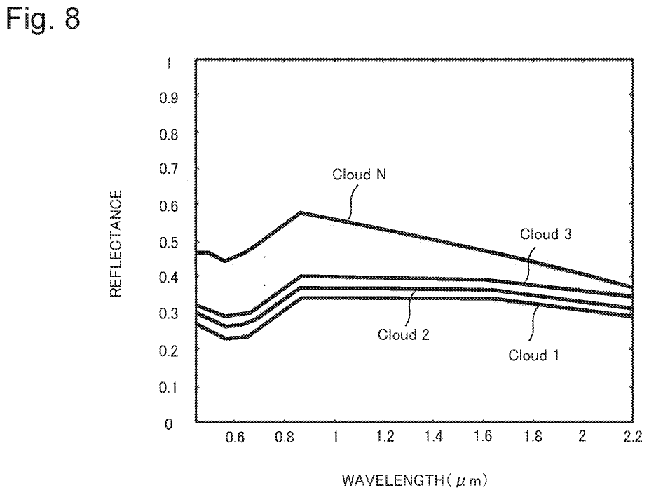

The matrix shown in FIG. 7 can be expressed as a graph with a reflectance as a vertical axis, and wavelength (μm) as a horizontal axis, such as shown in FIG. 8. In the graph, each of lines corresponds to a kind of clouds (cloud No.). Each of bands corresponds to its wavelength range.

The operations of steps S33 and S34 are the same as those of steps S23 and S24 in FIG. 5, respectively.

Steps S35 to S39 are performed for all pixels in an input image.

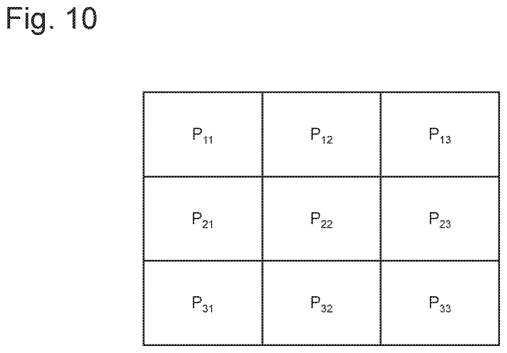

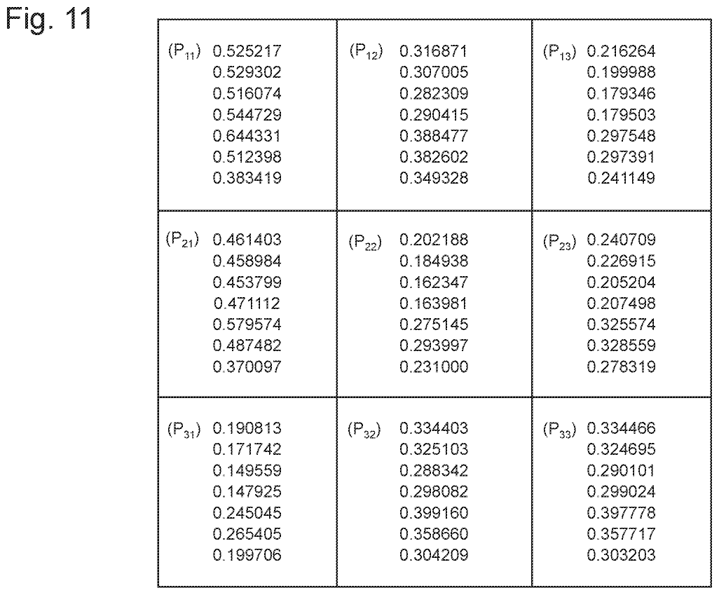

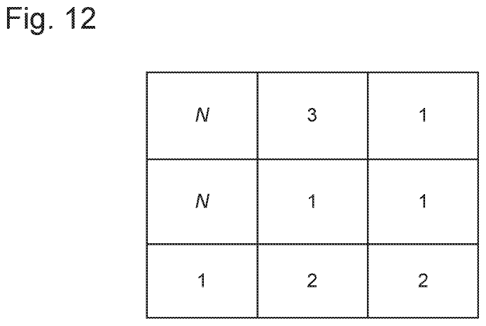

In step S35, cloud spectrum selection unit 31 selects a cloud spectrum among the extracted cloud spectra for each pixel in an image. For each pixel, cloud spectrum selection unit 31 finds a spectral angle between a cloud spectrum and each of cloud spectrum in the set of extracted cloud spectra using equation (12) and selects a clouds spectrum which gives the minimum angle. For example, a layout of pixels locations in a subset of an input image is given such as shown in FIG. 10, a table of spectral values of pixels in the subset in FIG. 10 is given such as shown FIG. 11, a table of an index number of selected cloud spectrum for pixels in the subset in FIG. 10 is given such as shown in FIG. 12.

For example, when cloud spectra extraction unit 13a extracts cloud spectra shown in FIG. 7, cloud spectrum selection unit 31 calculates a spectral angle between pixel P₁₁ in FIG. 11 and cloud 1 in FIG. 7 as follows:

$$W = {cos}^{- 1} [ \frac{\begin{matrix}0.268023 \times 0.525217 + 0.255365 \times \\ 0.529302 + ⋯ + 0.292430 \times 0.383419\end{matrix}}{\begin{matrix}( \sqrt{{0.268023}^{2} + {0.255365}^{2} + ⋯ + {0.292430}^{2}} ) \\ ( \sqrt{{0.525217}^{2} + {0.529302}^{2} + ⋯ + {0.383419}^{2}} )\end{matrix}} ]$$

$$W = {cos}^{- 1} ( 0.984005 ) = {10.26143881}^{o}$$

Similarly, the cloud spectrum selection unit 13a calculates a spectral angle for all clouds, such as:
cloud 2: W=9.0275470178°,
cloud 3: W=9.027547178°, . . . ,
cloud N: W=1.747962509°

Since the calculation result shows that pixel P₁₁ has the smallest angle with the cloud N, the cloud spectrum selection unit 31 determines that pixel P₁₁ is contaminated by the cloud N and the cloud N is selected for unmixing of pixel P₁₁.

After the cloud spectrum selection unit 31 selects a cloud spectrum corresponding to all pixels (nine pixels in FIGS. 10 and 11), the output is as shown in FIG. 12. The figures in the table indicates indices of selected cloud No. in FIG. 7 (or 8) for each pixel in FIG. 10 (or 11).

The operations of the steps S36 to S40 are the same as those of steps S25 to S29 in FIG. 5, respectively.

This is the end of the operation of the image processing device 300.

### Effect of Third Example Embodiment

According to the image processing device 300 of the fourth example embodiment in accordance with the present invention, in addition to the above effects described in the first and second example embodiments, the image processing device 300 can provide a correct estimation of cloud abundance and remove them even if there are different types of clouds in an input image. Instead of including multiple types of clouds in an image, if only one cloud spectrum is employed such as in the first and second embodiments, the cloud abundance may not be estimated correctly because of an inaccurate cloud spectrum. Therefore, the image processing device 300 finds representative pixels for each type of cloud and extracts a spectrum for the each type. The image processing device 300 selects an appropriate cloud spectrum among the extracted spectra for unmixing for each pixel. As a result, the image processing device 300 can estimate cloud abundance correctly even if different types of clouds are present in an image, and this results in accurate cloud detection and removal.

### Fourth Example Embodiment

In the third example embodiment, the spectra of clouds contained in the image are extracted for each image input. However, it takes time and in some case, such as a case where an input image has only a thin cloud cover, accurate extraction would be difficult because finding a pure cloud pixel in the image is troublesome. Assuming such a case, if all potential cloud spectra are stored in advance, the determination of the cloud spectrum becomes fast and accurate. In the fourth example embodiment, image processing device 400 which holds a cloud spectra database and selects a cloud spectrum or multiple cloud spectra in an inputted image from the cloud spectra database will be described.

### <<Image Processing Device>>

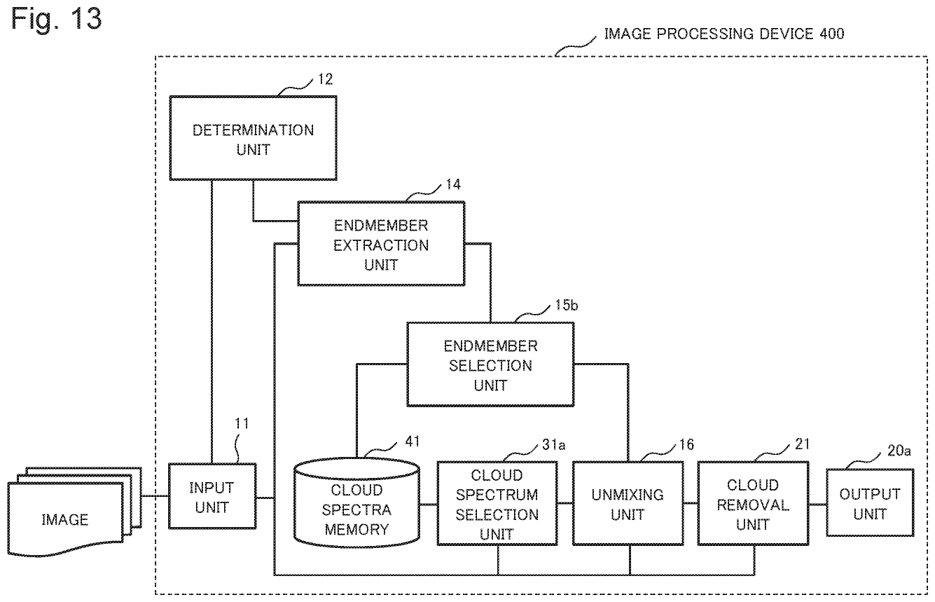

FIG. 13 is a block diagram showing the configuration of image processing device 400 of the second example embodiment in accordance with the present invention. Image processing device 400 includes: input unit 11, determination unit 12, cloud spectra memory 41, cloud spectrum selection unit 31a, endmember extraction unit 14, endmember selection unit 15b, unmixing unit 16, cloud removal unit 21, and output unit 20a.

Cloud spectra memory 41 stores various cloud spectra which are generally and possibly observed in satellite images in a database. Cloud spectra can be stored as a table (see FIG. 7) or as a graph (see FIG. 8).

The information in cloud spectra memory 41 is available to endmember selection unit 15b and cloud spectrum selection unit 31a via wired or wireless communication.

Endmember selection unit 15b acquires the set of cloud spectra from cloud spectra memory 41 and the set of endmember spectra from endmember extraction unit 14. Endmember selection unit 15b calculates a spectral angle between each of cloud spectrum in the set of cloud spectra and each of endmember spectrum in the set of endmember spectra by using equation (12) as described in the first example embodiment. If the angle for any pair of a cloud spectrum and an endmember spectrum is less than a threshold, the endmember spectrum is assumed to be a noisy cloud spectrum. And endmember selection unit 15b removes the noisy cloud spectrum from the set of endmember spectra. After comparing all endmember spectra with all cloud spectra, endmember selection unit 15b assembles the remaining endmember spectra as a set of endmember spectra and sends it to unmixing unit 16.

Cloud spectrum selection unit 31a (corresponding to cloud spectrum acquisition unit 502 in the fifth example embodiment) obtains the cloud spectrum from the cloud spectra memory 41. Specifically, cloud spectrum selection unit 31a receives an input image from input unit 11 and a set of cloud spectra from cloud spectra memory 41. Cloud spectrum selection unit 31a selects a cloud spectrum for a target pixel from the set of cloud spectra. For each pixel, cloud spectrum selection unit 31a selects the spectrally closest cloud spectrum with the pixel's spectrum in a feature space of multiple dimensions, each of which corresponds to a specific wavelength band in the image.

Other units are the same as the third example embodiment.

### <<Operation of Image Processing Device>>

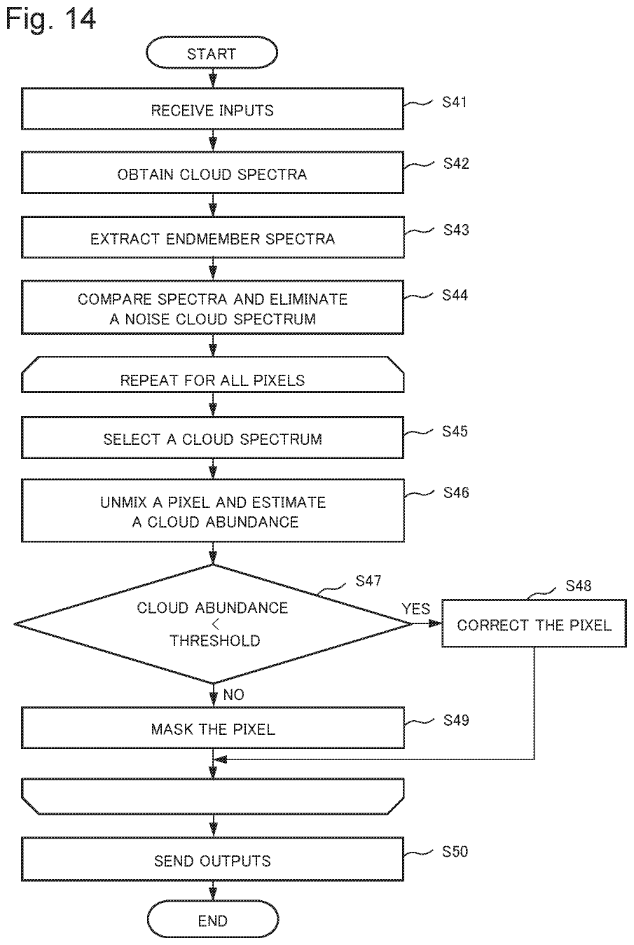

FIG. 14 shows a flowchart which shows the operation of image processing device 400, on the assumption that required cloud spectra are stored in cloud spectra memory 41.

The operations of step S41 is the same as those of step S31.

In step S42, endmember selection unit 15b acquires the set of cloud spectra from cloud spectra memory 41.

The operations of step S43 to S44 are the same as those of steps S33 to S34 in FIG. 9, respectively.

In step S45, cloud spectrum selection unit 31a obtains a set of cloud spectra from cloud spectra memory 41, and selects a cloud spectrum among the set of cloud spectra for each pixel in an image. For each pixel, cloud spectrum selection unit 31a finds a spectral angle between a cloud spectrum and each of cloud spectrum in the set of cloud spectra using equation (12) and selects a cloud spectrum which gives the minimum angle.

The operations of step S46 to S50 are the same as those of steps S36 to S40 in FIG. 9, respectively.

This is the end of the operation of the image processing device 400.

### Effect of Fourth Example Embodiment

The image processing device 400 of the fourth example embodiment in accordance with the present invention can estimate a cloud spectrum fast and correctly, and consequently calculate a cloud abundance in short time and accurately even if no pure pixel of a cloud exists in an input image.

The reason is that cloud spectra are selected from a database of cloud spectra instead of extracting cloud spectra from the input image. Since all possible spectra are available from the database, cloud abundance can be estimated accurately, and this results in accurate cloud detection and removal.

### Fifth Example Embodiment

In the fifth example embodiment, an image processing device 500 is described. The image processing device 500 indicates the minimum configuration of the first to fourth embodiments. FIG. 15 is a block diagram showing the configuration of image processing device 500 of the fifth example embodiment in accordance with the present invention.

Image processing device 500 is for detecting and correcting areas affected by a cloud in an input image. Image processing device 500 includes: endmember extraction unit 501, cloud spectrum acquisition 502, endmember selection unit 503 and unmixing unit 504.

Endmember extraction unit 501 extracts a set of spectra of one or more endmembers from the input image.

Cloud spectrum acquisition 502 acquires one cloud spectrum in the input image.

Endmember selection unit 503 compares the endmember spectra with the cloud spectrum and removing one or more of the endmember spectra, which are the same or similar to the cloud spectrum, from the set of spectra and outputs the set as an authentic set of spectra.

Unmixing unit 504 derives fractional abundances of the authentic set of spectra and the cloud spectra for each pixel in the input image, for detecting cloud pixels.

The image processing device 500 of the fifth example embodiment is capable of accurately detecting and correcting areas affected by clouds by ensuring absence of the noisy cloud spectrum, which are the same or similar to the cloud spectrum, in a set of spectra used for unmixing. The reason is that endmember selection unit 503 removes the noisy cloud spectra from the set of spectra before unmixing.

### <Configuration of Information Processing Apparatus>

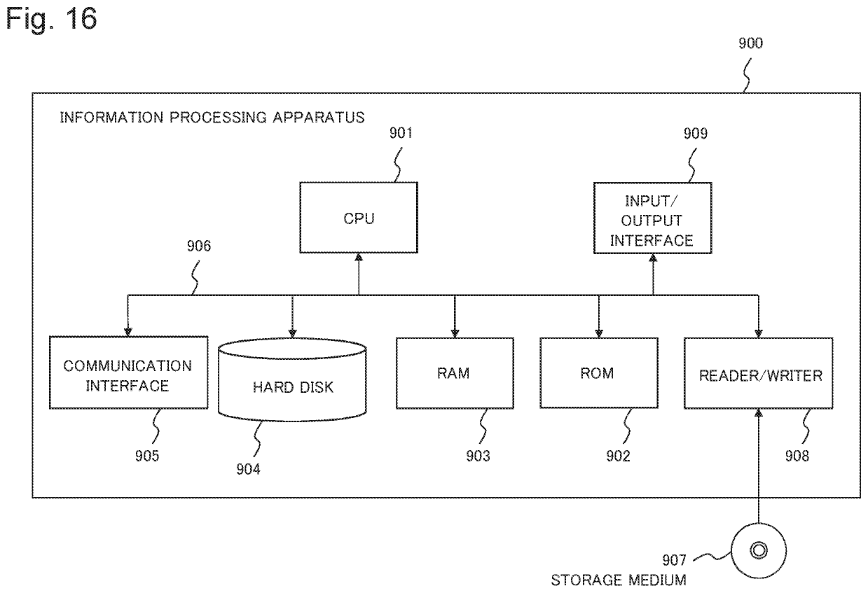

FIG. 16 illustrates, by way of example, a configuration of an information processing apparatus 900 (computer) which can implement an image processing device relevant to an example embodiment of the present invention. In other words, FIG. 16 illustrates a configuration of a computer (information processing apparatus) capable of implementing the devices in FIGS. 1, 4, 6, 13 and 14, representing a hardware environment where the individual functions in the above-described example embodiments can be implemented.

The information processing apparatus 900 illustrated in FIG. 16 includes the following components:

CPU 901 (Central_Processing_Unit);

ROM 902 (Read_Only_Memory);

RAM 903 (Random_Access_Memory);

Hard disk 904 (storage device);

Communication interface to an external device 905;

Reader/writer 908 capable of reading and writing data stored in a storage medium 907 such as CD-ROM (Compact_Disc_Read_Only_Memory); and

Input/output interface 909.

The information processing apparatus 900 is a general computer where these components are connected via a bus 906 (communication line).

The present invention explained with the above-described example embodiments as examples is accomplished by providing the information processing apparatus 900 illustrated in FIG. 16 with a computer program which is capable of implementing the functions illustrated in the block diagrams (FIGS. 1, 4, 6, 13 and 14) or the flowcharts (FIGS. 3, 5, 9 and 14) referenced in the explanation of these example embodiments, and then by reading the computer program into the CPU 901 in such hardware, interpreting it, and executing it. The computer program provided to the apparatus can be stored in a volatile readable and writable storage memory (RAM 903) or in a non-volatile storage device such as the hard disk 904.

In addition, in the case described above, general procedures can now be used to provide the computer program to such hardware. These procedures include, for example, installing the computer program into the apparatus via any of various storage medium 907 such as CD-ROM, or downloading it from an external source via communication lines such as the Internet. In these cases, the present invention can be seen as being composed of codes forming such computer program or being composed of the storage medium 907 storing the codes.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the above-described example embodiments can be described as, but not limited to, the following supplementary notes.

(Supplementary Note 1) An image processing device for detecting and correcting areas affected by a cloud in an input image comprising:

an endmember extraction means for extracting a set of spectra of one or more endmembers from the input image;

a cloud spectrum acquisition means for acquiring one cloud spectrum in the input image;

an endmember selection means for comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra; and

an unmixing means for deriving, for each pixel in the input image, one or more fractional abundances of the one or more endmembers and a fractional abundance of cloud in the authentic set of spectra, and detecting one or more cloud pixels in the input image.

(Supplementary Note 2) The image processing device according to Supplementary Note 1, further comprising:

a cloud removal means for determining, for each of the pixels in the input image, whether the pixel is affected by a thin cloud or a thick cloud, correcting the pixel that is determined as being affected by the thin cloud, and masking the pixel affected by the thick cloud.

(Supplementary Note 3) The image processing device according to Supplementary Note 1 or 2, wherein

the cloud spectrum acquisition means obtains the cloud spectrum by extracting the cloud spectrum from the input image.

(Supplementary Note 4) The image processing device according to Supplementary Note 1 or 2, further comprising:

a cloud spectra memory for storing various types of cloud spectra which are possibly observed in an input image,

wherein, the cloud spectrum acquisition means obtains the cloud spectrum from the cloud spectra memory.

(Supplementary Note 5) The image processing device according to any one of Supplementary Notes 1 to 4, wherein the cloud spectrum acquisition means extracts plural kinds of cloud spectra from clouds present in the input image.
(Supplementary Note 6) The image processing device according to Supplementary Note 5, further comprising:

a cloud spectrum selection means for selecting, for each pixel in the input image, one cloud spectrum from among the plurality of cloud spectra.

(Supplementary Note 7) The image processing device according to Supplementary Note 5, further comprising:

a cloud spectrum selection means for selecting a cloud spectrum, for each pixel in the input image, from the cloud spectra memory.

(Supplementary Note 8) An image processing method for detecting and correcting areas affected by a cloud in an input image comprising:

extracting a set of spectra of one or more endmembers from the input image;

acquiring one cloud spectrum in the input image;

comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra; and

deriving, for each pixel in the input image, one or more fractional abundances of the one or more endmembers and a fractional abundance of cloud in the authentic set of spectra, and detecting one or more cloud pixels in the input image.

(Supplementary Note 9) The image processing method according to Supplementary Note 8, further comprising:

determining, for each of the pixels in the input image, whether the pixel is affected by a thin cloud or a thick cloud, correcting the pixel that is determined as being affected by the thin cloud, and masking the pixel affected by the thick cloud.

(Supplementary Note 10) The image processing method according to Supplementary Note 8 or 9, wherein

in the acquiring, obtaining the cloud spectrum by extracting the cloud spectrum from the input image.

(Supplementary Note 11) The image processing method according to Supplementary Note 8 or 9, wherein

in the acquiring, obtaining the cloud spectrum from the cloud spectra memory which stores various types of cloud spectra which are possibly observed in an input image.

(Supplementary Note 12) The image processing method according to any one of Supplementary Notes 8 to 11, wherein, in the acquiring, extracting plural kinds of cloud spectra from clouds present in the input image.
(Supplementary Note 13) The image processing method according to Supplementary Note 12, further comprising:

selecting, for each pixel in the input image, one cloud spectrum from among the plurality of cloud spectra.

(Supplementary Note 14) The image processing method according to Supplementary Note 12, further comprising:

selecting a cloud spectrum, for each pixel in the input image, from the cloud spectra memory.

(Supplementary Note 15) An storage medium storing an image processing program to cause a computer for detecting and correcting areas affected by a cloud in an input image, the program comprising:

extracting a set of spectra of one or more endmembers from the input image;

acquiring one cloud spectrum in the input image;

comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra, and outputting a resultant set of spectra as an authentic set of spectra; and

deriving, for each pixel in the input image, one or more fractional abundances of the one or more endmembers and a fractional abundance of cloud in the authentic set of spectra, and detecting one or more cloud pixels in the input image.

(Supplementary Note 16) The storage medium according to Supplementary Note 15, further comprising:

determining, for each of the pixels in the input image, whether the pixel is affected by a thin cloud or a thick cloud, correcting the pixel that is determined as being affected by the thin cloud, and masking the pixel affected by the thick cloud.

(Supplementary Note 17) The storage medium according to Supplementary Note 15 or 16, wherein

in the acquiring, obtaining the cloud spectrum by extracting the cloud spectrum from the input image.

(Supplementary Note 18) The storage medium according to Supplementary Note 15 or 16, wherein

in the acquiring, obtaining the cloud spectrum from the cloud spectra memory which stores various types of cloud spectra which are possibly observed in an input image.

(Supplementary Note 19) The storage medium according to any one of Supplementary Notes 15 to 18, wherein, in the acquiring, extracting plural kinds of cloud spectra from clouds present in the input image.
(Supplementary Note 20) The storage medium according to Supplementary Note 19, further comprising:

selecting, for each pixel in the input image, one cloud spectrum from among the plurality of cloud spectra.

(Supplementary Note 21) The storage medium according to Supplementary Note 19, further comprising:

selecting a cloud spectrum, for each pixel in the input image, from the cloud spectra memory.

### INDUSTRIAL APPLICABILITY

The present invention can be applied as a pre-processing tool for compensating environmental effects in capturing of satellite images before advance level satellite image processing operations.

### REFERENCE SIGNS LIST

01: input unit
02: receiving unit
03: cloud spectrum extraction unit
04: endmember extraction unit
05: unmixing unit
06: cloud removal unit
11: input unit
12: receiving unit
13, 13a: cloud spectrum extraction unit
14: endmember extraction unit
15, 15a: endmember selection unit
16: unmixing unit
21: cloud removal unit
20, 20a: output unit
31, 31a: cloud spectrum selection unit
41: cloud spectra memory
100: image processing device
200: image processing device
300: image processing device
400: image processing device
500: image processing device
900: information processing apparatus
901 CPU
902: ROM
903: RAM
904: hard disk
905: communication interface
906: bus
907: storage medium
908: reader/writer
909: input/output interface

1. An image processing device for detecting and correcting areas affected by a cloud in an input image comprising:
a memory, and
one or more processors functioning as:
an endmember extraction unit configured to extract a set of spectra of one or more endmembers from the input image;
a cloud spectrum acquisition unit configured to acquire one cloud spectrum in the input image;
an endmember selection unit configured to compare the endmember spectra with the cloud spectrum, remove one or more spectra from the set of spectra of the endmember spectra, the one or more spectra being same as or similar to the one cloud spectrum, and output a resultant set of spectra as an authentic set of spectra; and
an unmixing unit configured to derive, for each pixel in the input image, one or more fractional abundances of the one or more endmembers and a fractional abundance of cloud in the authentic set of spectra, and detect one or more cloud pixels in the input image.

2. The image processing device according to claim 1, further comprising:
a cloud removal unit configured to determine, for each of the pixels in the input image, whether the pixel is affected by a thin cloud or a thick cloud, correct the pixel that is determined as being affected by the thin cloud, and mask the pixel affected by the thick cloud.

3. The image processing device according to claim 1, wherein
the cloud spectrum acquisition unit obtains the cloud spectrum by extracting the cloud spectrum from the input image.

4. The image processing device according to claim 1, further comprising:
a cloud spectra memory for storing various types of cloud spectra which are possibly observed in an input image,
wherein, the cloud spectrum acquisition unit obtains the cloud spectrum from the cloud spectra memory.

5. The image processing device according to claim 1, wherein the cloud spectrum acquisition unit extracts plural kinds of cloud spectra from clouds present in the input image.

6. The image processing device according to claim 5, further comprising:
a cloud spectrum selection unit configured to select, for each pixel in the input image, one cloud spectrum from among the plurality of cloud spectra.

7. The image processing device according to claim 5, further comprising:
a cloud spectrum selection unit configured to select a cloud spectrum, for each pixel in the input image, from the cloud spectra memory.

8. An image processing method for detecting and correcting areas affected by a cloud in an input image comprising:
extracting a set of spectra of one or more endmembers from the input image;
acquiring one cloud spectrum in the input image;
comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra; and
deriving, for each pixel in the input image, one or more fractional abundances of the one or more endmembers and a fractional abundance of cloud in the authentic set of spectra, and detecting one or more cloud pixels in the input image.

9. The image processing method according to claim 8, further comprising:
determining, for each of the pixels in the input image, whether the pixel is affected by a thin cloud or a thick cloud, correcting the pixel that is determined as being affected by the thin cloud, and masking the pixel affected by the thick cloud.

10. The image processing method according to claim 8, wherein
in the acquiring, obtaining the cloud spectrum by extracting the cloud spectrum from the input image.

11. The image processing method according to claim 8, wherein
in the acquiring, obtaining the cloud spectrum from the cloud spectra memory which stores various types of cloud spectra which are possibly observed in an input image.

12. The image processing method according to claim 8, wherein, in the acquiring, extracting plural kinds of cloud spectra from clouds present in the input image.

13. The image processing method according to claim 12, further comprising:
selecting, for each pixel in the input image, one cloud spectrum from among the plurality of cloud spectra.

14. The image processing method according to claim 12, further comprising:
selecting a cloud spectrum, for each pixel in the input image, from the cloud spectra memory.

15. A non-transitory computer readable storage medium storing an image processing program to cause a computer for detecting and correcting areas affected by a cloud in an input image, the program comprising:
extracting a set of spectra of one or more endmembers from the input image;
acquiring one cloud spectrum in the input image;
comparing the endmember spectra with the cloud spectrum, removing one or more spectra from the set of spectra of the endmember spectra, the one or more spectra being same as or similar to the one cloud spectrum, and outputting a resultant set of spectra as an authentic set of spectra, and outputting a resultant set of spectra as an authentic set of spectra; and
deriving, for each pixel in the input image, one or more fractional abundances of the one or more endmembers and a fractional abundance of cloud in the authentic set of spectra, and detecting one or more cloud pixels in the input image.

16. The storage medium according to claim 15, further comprising:
determining, for each of the pixels in the input image, whether the pixel is affected by a thin cloud or a thick cloud, correcting the pixel that is determined as being affected by the thin cloud, and masking the pixel affected by the thick cloud.

17. The storage medium according to claim 15, wherein
in the acquiring, obtaining the cloud spectrum by extracting the cloud spectrum from the input image.

18. The storage medium according to claim 15, wherein
in the acquiring, obtaining the cloud spectrum from the cloud spectra memory which stores various types of cloud spectra which are possibly observed in an input image.

19. The storage medium according to claim 15, wherein, in the acquiring, extracting plural kinds of cloud spectra from clouds present in the input image.

20. The storage medium according to claim 19, further comprising:
selecting, for each pixel in the input image, one cloud spectrum from among the plurality of cloud spectra.

21. (canceled)
